(19) United States
(12) Patent Application Publication
(10) Pub. No.: US 2026/0122101 A1
(43) Pub. Date: Apr. 30, 2026

(54) TRAINING AND DEPLOYING RANSOMWARE URL CLASSIFIERS

(71) Applicant: Palo Alto Networks, Inc., Santa Clara, CA (US)

(72) Inventors: Shan Huang, San Jose, CA (US); Fang Liu, College Station, TX (US); Joe Larry Allen, III, Santa Clara, CA (US); William Redington Hewlett, II, Mountain View, CA (US); Oleksii Starov, Sunnyvale, CA (US)

(21) Appl. No.: 18/932,215

(22) Filed: Oct. 30, 2024

(51) Int. Cl. H04L 9/40

(52) U.S. Cl. CPC H04L 63/1441

(57) ABSTRACT

A pipeline has been created to efficiently train and deploy an offline ransomware URL classifier and inline ransomware URL classifiers. Efficiency in training is gained with transfer learning from a trained malicious URL classifier. Both the offline ransomware URL classifier and the inline ransomware URL classifier are deployed for a comprehensive detection solution that provides speed and accuracy in detection. The offline ransomware URL classifier has greater accuracy than the inline ransomware URL classifier while the inline ransomware URL classifier classifies more quickly. The solution deploys the offline ransomware URL to classify malicious URLs indicated from trusted/knowledgeable sources and indicate ransomware URLs in a dataset. The inline ransomware URL classifier is deployed to security appliances. The security appliance accesses the dataset to detect previously seen ransomware URLs (by the offline ransomware URL classifier) and uses the inline ransomware URL classifier for detection of unknown or first impression ransomware URLs.

### BACKGROUND

The disclosure generally relates to data processing and computing arrangements based on computational models (e.g., CPC subclass G06N and CPC subclass G06F 16).

Ransomware refers to malicious software used to hold valuable assets (e.g., files or data) for ransom. Typically, a ransomware attack uses social engineering to trick a user to perform some action(s) that facilitates installation or execution of the malicious software. This malicious software then identifies assets and prevents access of the assets either by encrypting the assets or denying access to a system that hosts the assets. More than 70% of ransomware attacks use a uniform resource locator (URL) to deliver a ransomware payload. The URL, referred to as a ransomware URL, is used to distribute, install, or execute the malicious software or ransomware.

### BRIEF DESCRIPTION OF THE DRAWINGS

Embodiments of the disclosure may be better understood by referencing the accompanying drawings.

FIG. 1 is a diagram illustrating training an ensemble to generate ransomware URL classifiers with the use of transfer learning from a trained malicious URL classifier.

FIG. 2 is a diagram illustrating creation of an offline ransomware URL classifier and an inline ransomware URL classifier.

FIG. 3 is a diagram illustrating use of the offline ransomware URL classifier created in FIG. 2.

FIG. 4 is a diagram illustrating deployment and use of the inline ransomware URL classifier and a ransomware URL dataset to which an offline ransomware URL classifier contributes.

FIG. 5 is a flowchart of example operations for training a model to create ransomware URL classifiers.

FIG. 6 is a flowchart of example operations for detecting ransomware URLs when concurrently invoking a malicious URL classifier and an inline ransomware URL classifier.

FIG. 7 is a flowchart of example operations for detecting ransomware URLs when serially invoking a malicious URL classifier and an inline ransomware URL classifier.

FIG. 8 depicts an example computer system with a trainer and deployer for ransomware URL classifiers.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Terminology

This description uses “offline” and “inline” as terms contrasting with each other. In networking, “inline” when used as a modifier for processing of network traffic refers to processing network traffic in the communication path that the network traffic is traversing (e.g., on the router or gateway). Offline is being used as a parallel contrasting modifier to indicate that the subject is not inline. Thus, an inline classifier is deployed to be in a communication path for network traffic while an offline classifier is not deployed in a communication path of network traffic.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Ransomware victims can be individuals, large corporations, medical facilities, government agencies, etc. The significant impact of ransomware on ransomware victims makes ransomware URLs more harmful and notorious as a sub-class among malicious URLs which can also include phishing URLs, grayware URLs, command-and-control URLs, etc. This fuels the urgency for quickly identifying a ransomware URL. As all ransomware URLs are malicious URLs, the URLs will presumably be filtered or blocked. However, a ransomware URL may require additional action and may be governed by a different security policy than a non-ransomware malicious URL.

A pipeline has been created to efficiently train and deploy an offline ransomware URL classifier and inline ransomware URL classifiers. With transfer learning from a trained malicious URL classifier, a quality classifier can be obtained with efficiency. Both the offline ransomware URL classifier and the inline ransomware URL classifier, which is a subset of the ensembles of the offline ransomware URL, are deployed for a comprehensive detection solution that provides speed and accuracy in detection. The offline ransomware URL classifier has greater accuracy than the inline ransomware URL classifier while the inline ransomware URL classifier classifies more quickly. The solution deploys the offline ransomware URL to classify malicious URLs indicated from trusted/knowledgeable sources (“known malicious URLs”). Those of the known malicious URLs classified as ransomware URLs by the offline ransomware URL classifier are indicated in a dataset of ransomware URLs (i.e., in a repository/database). The inline ransomware URL classifier is made available (e.g., deployed locally or published as a service) to security appliances (e.g., firewalls) and/or other types of clients, such as other services and applications. The security appliance accesses the ransomware URL dataset to detect previously seen ransomware URLs (by the offline ransomware URL classifier) and uses the inline ransomware URL classifier for detection of unknown or first impression ransomware URLs. Thus, a security appliance gains the accuracy and more comprehensive view of URLs from the offline ransomware URL classifier via the ransomware URL dataset and the agility of the inline ransomware URL classifier for unseen/first impression malicious URLs.

### Example Illustrations

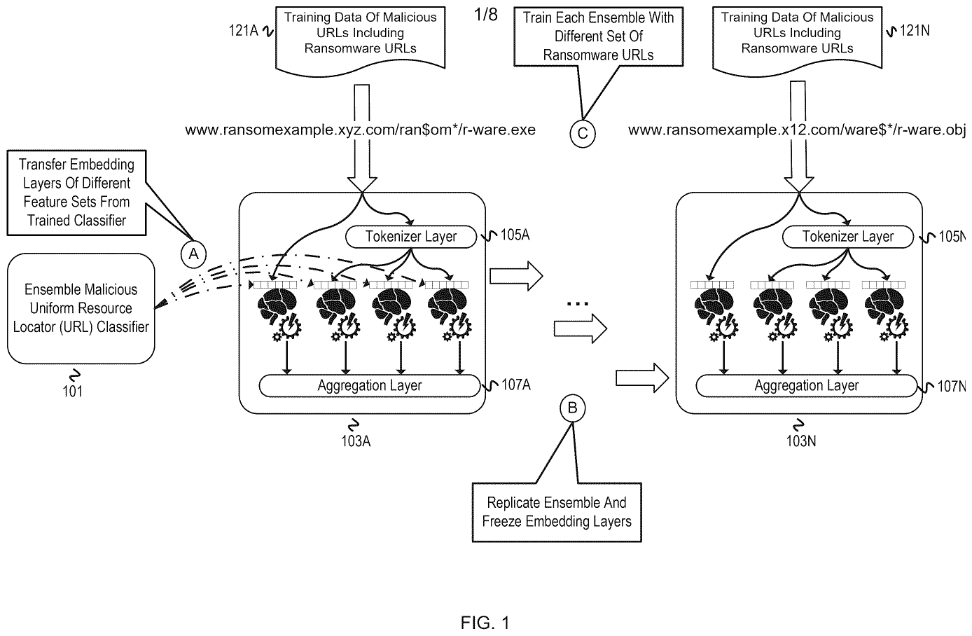

FIGS. 1-4 are diagrams illustrating an example of training and deploying the ransomware URL detection solution that employs an offline ransomware URL classifier and an inline ransomware URL classifier. FIG. 1 is a diagram illustrating training an ensemble to generate ransomware URL classifiers with the use of transfer learning from a trained malicious URL classifier. Each of the FIGS. 1-4 is annotated with a series of letters, each representing a stage of one or more operations. Although these stages are ordered for this example, the stages illustrate one example to aid in understanding this disclosure and should not be used to limit the claims. Subject matter falling within the scope of the claims can vary from what is illustrated. FIG. 1 is annotated with a series of letters A-C.

At stage A, transfer learning is used to leverage the knowledge of an ensemble malicious URL classifier 101. Millions of benign and non-ransomware malicious URLs are available on a monthly basis for training a malicious URL classifier. In contrast, a training data may accumulate 300,000 ransomware URLs over 6 months. The embedding layers of the ensemble malicious URL classifier 101 are extracted from the ensemble malicious URL classifier 101 and added to an ensemble 103A. The ensemble 103A is illustrated as a resulting ensemble but is built from assembling an input layer, the transferred embedding layers, and a head. The embedding layers being transferred include embedding layers across multiple channels of feature sets. In FIG. 1, the ensemble 103A is illustrated as having four neural networks, each with a different channel of inputs/features flowing into different channels of the transferred embedding layers. Embodiments are not limited to neural networks but can use any of a variety of machine learning models/learners that can be trained to be a classifier. As examples, the different channels of feature sets of a URL can be: a character feature set, a token feature set, a token by character feature set, and token randomness or entropy feature. The token randomness feature quantifies or scores randomness of the sequence of tokens that form a URL. The token randomness channel can measure or score randomness of the token sequence of a URL according to various techniques, such as using a second-order Markov chain or Shannon entropy rate estimation. Accordingly, the ensemble 103A is depicted as including a tokenizer layer 105A to generate the tokens from a URL. After adding the embedding layer, a head is added. FIG. 1 depicts an aggregation layer 107A added to the ensemble 103A after the fully connected layers of the neural networks.

At stage B, the ensemble 103A is replicated a configured number of times to produce additional ensembles up to an ensemble 103N that is depicted with a tokenizer layer 105N and an aggregation layer 107N. After replication, the embedding layers across the ensembles 103A-103N are frozen.

At stage C, a trainer trains each ensemble 103A-103N with a different set of ransomware URLs. The trainer trains the ensemble 103A with malicious URLs in a training dataset 121A. The trainer trains the ensemble 103N with malicious URLs in a training dataset 121N. The training dataset 121A includes ransomware URLs that are different than ransomware URLs included in the training dataset 121N. However, the training datasets 121A, 121N can have non-ransomware malicious URLs in common.

FIG. 1 depicts an example ransomware URL “www.ransomexample.xyz.com/ran$om*/r-ware.exe” being fed into the ensemble 103A and an example ransomware URL “www. ransomexample.x12.com/ware$*/r-ware.obj” being fed into the ensemble 103N.

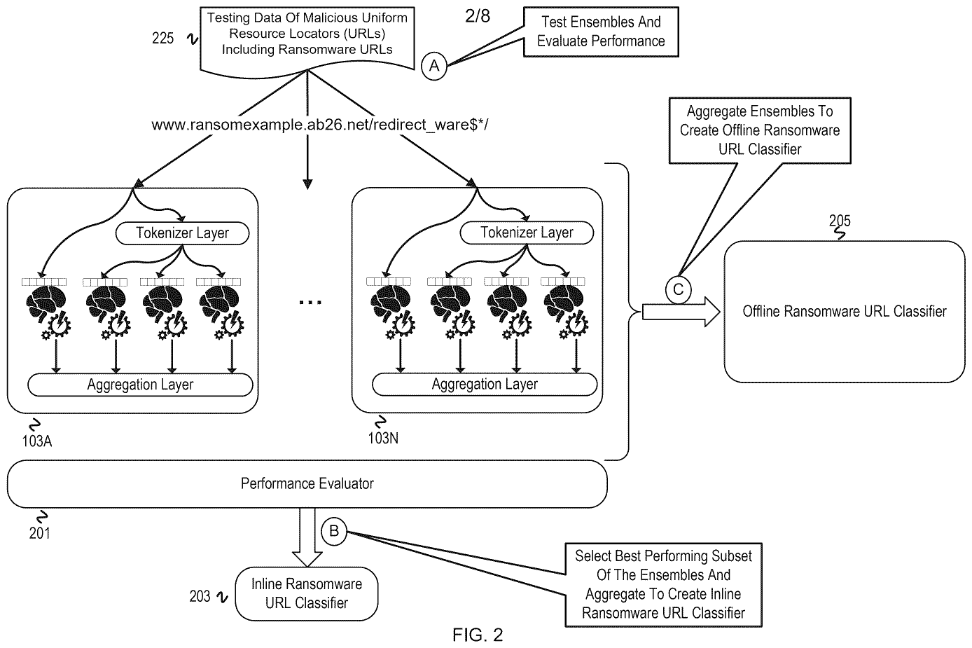

FIG. 2 is a diagram illustrating creation of an offline ransomware URL classifier and an inline ransomware URL classifier. After the training illustrated in FIG. 1, the trained ensembles are aggregated to form an offline ransomware URL classifier 205 and individually tested and evaluated to create an inline ransomware URL classifier 203. Prior to the aggregating to form the offline ransomware URL classifier 205, the ensembles are likely tested to determine whether performance is sufficient for use.

However, the testing referred to in FIG. 2 relates to creating the inline ransomware URL classifier 203. FIG. 2 is annotated with a series of letters A-C.

At stage A, each of the ensembles 103A-103N is tested and performance evaluated. Beforehand, a dataset of malicious URLs that include ransomware URLs was split between a training set and a testing set. In FIG. 2, the testing dataset 225 is the testing set. While the testing dataset 225 can be divided across the ensembles 103A 103N, it is not necessary. Performance evaluation is with respect to a combination of true positive (TPR) rate and false positive rate (FPR).

At stage B, a performance evaluator 201 evaluates the performance of each of the ensembles 103A-103N. Based on the performance evaluation, the performance evaluator 201 selects a best performing subset of the ensembles 103A-103N. The number of ensembles within the selected subset will be according to a configured value. The selected subset is then aggregated to create the inline ransomware URL classifier 203. Aggregating can be adding or associating a pooling layer to the subset. Implementations can use other aggregating techniques, such as majority voting or soft voting depending upon the architecture of the ensemble.

At stage C, the ensembles 103A-103N are aggregated to create the offline ransomware URL classifier 205. Again, aggregating can be adding or associating a pooling layer across the ensembles 103A-103N.

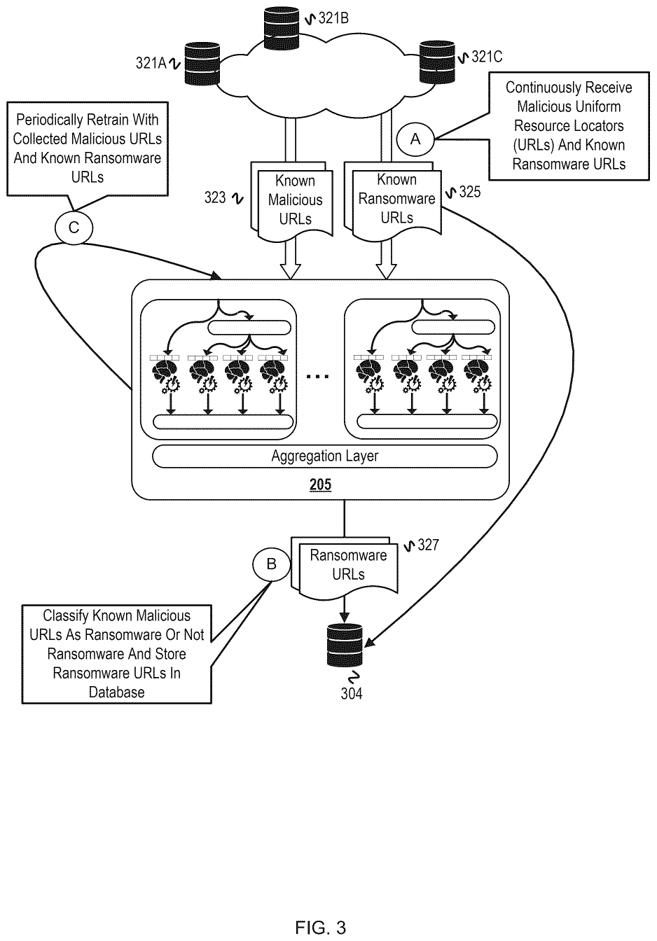

FIG. 3 is a diagram illustrating use of the offline ransomware URL classifier created in FIG. 2. In FIG. 3, the offline ransomware URL classifier 205 has been deployed in an environment that allows write access to a repository 304 that hosts a ransomware URL dataset and allows obtaining data of known malicious URLs 323 and known ransomware URLs 325. The offline ransomware URL classifier 205 is configured or deployed to obtain the known malicious URLs 323 and known ransomware URLs 325 from trusted sources 321A-321C. For example, a connector can be configured to an online service, a subscription to a security vendor database, and a subscription to an expert maintained data source. FIG. 3 is annotated with a series of letters A-C.

At stage A, the environment of the offline ransomware URL classifier 205 continuously receives/collects over time the known malicious URLs 323 and the known ransomware URLs 325. The known ransomware URLs 325 are stored in the repository 304, thus maintaining an up-to-date listing of ransomware URLs. Often, the ransomware URLs identified by the trusted sources 321A-321C will include initial or original ransomware URLs which will then be followed by variants. The known malicious URLs 323 are fed into the offline ransomware URL classifier 205 for classifying.

At stage B, the offline ransomware URL classifier 205 classifies each of the known malicious URLs 323 as ransomware or not ransomware. If the offline ransomware URL classifier 205 classifies one of the malicious URLs 323 as a ransomware URL, then the offline ransomware URL classifier 205 stores the URL classified as a ransomware URL 327 in the repository 304.

At stage C, the offline ransomware URL classifier 205 is periodically retrained with the collected known malicious URLs 323 and known ransomware URLs 325. The periodic training uses recent (e.g., most recent 6 months) collected data, to retrain the offline ransomware URL classifier 205. This allows the offline ransomware URL classifier 205 to maintain or improve accuracy despite evolving ransomware URLs and shifts in variants. When stored into the repository, the entries for the known ransomware URLs 325 can be marked to distinguish them from the ransomware URLs 327 classified by the offline ransomware URL classifier 205 to avoid potential bias from training with its own classifications when retraining.

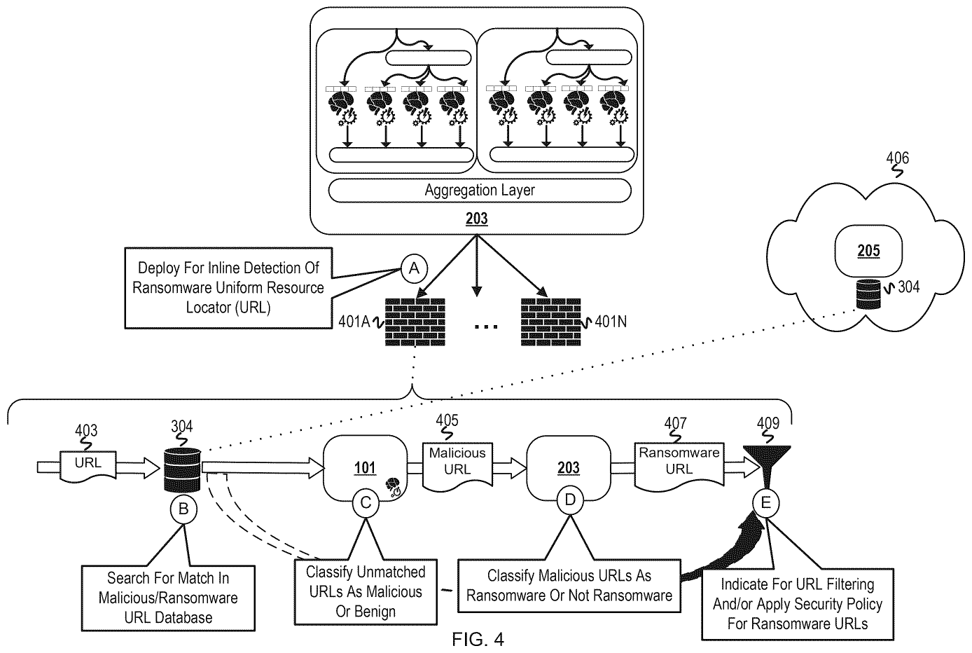

FIG. 4 is a diagram illustrating deployment and use of the inline ransomware URL classifier and a ransomware URL dataset to which an offline ransomware URL classifier contributes. FIG. 4 is annotated with a series of letters A E for operational stages corresponding to the firewall 401A.

At stage A, the inline ransomware URL classifier 203 has been deployed to firewalls 401A-401N. This deployment may be locally hosting the inline ransomware URL classifier 203 in each of the firewalls 401A-401N, installing an agent in each of the firewalls 401A-401N that communicates with the inline ransomware URL classifier 203, or exposing the inline ransomware URL classifier 203 as a service to each of the firewalls 401A-401N. The deployed classifier is depicted as a ransomware URL classifier 203A in FIG. 4.

At stage B, the firewall 401A detects a URL 403 in network traffic and searches the repository 304 for a match with the URL 403. As described with reference to FIG. 3, a dataset of ransomware URLs is hosted in the repository 304. FIG. 4 depicts the offline ransomware URL classifier 205 and the repository 304 as remotely hosted, such as by a cloud service platform 406. However, the content or at least some of the content can be cached at the firewall 401A. If a hit/match with a ransomware URL is found, then the URL 403 would be filtered and a security policy corresponding to ransomware URLs would be applied at stage E. In some implementations, malicious URLs are also stored in the dataset allowing for rapid filtering of malicious URLs based on a match instead of invoking a classifier.

At stage C, the firewall 401A classifies the URL 403 as malicious or benign since there was no match with a URL in the ransomware URL dataset of the repository 304. The firewall 401A invokes the malicious URL classifier 101, which was used for transfer learning in FIG. 1. For example, the firewall 401A generates a call to a service providing the malicious URL classifier 101. It is not necessary for the inline ransomware URL classifier 203 to operate with the same URL classifier that was used as a source of the embedding layer.

At stage D, the firewall 401A classifies the URL 403 as a ransomware URL or not ransomware URL. FIG. 4 depicts the URL 403 as classified as a malicious URL 405 by the classifier 101. The firewall 401A invokes the inline ransomware URL classifier 203 to classify the malicious URL 405. For example, the firewall 401A generates a call to a service providing the ransomware URL classifier 203. FIG. 4 depicts the malicious URL 405 (i.e., the URL 403) as ransomware URL 407 if classified as a ransomware URL by the inline ransomware URL classifier 203. While inline can mean that the ransomware URL classifier 203 is hosted locally with the firewall 401A, the ransomware URL classifier 203 can be inline (i.e., in the communication path) even when provided via a web-based service because corresponding traffic can be momentarily delayed until a response is received.

At stage E, the firewall 401A indicates the ransomware URL 407 for URL filtering by filter 409. Filtering may be performed as part of applying a security policy defined for ransomware URLs. The security policy can indicate other operations in addition to blocking any request for the ransomware URL 407.

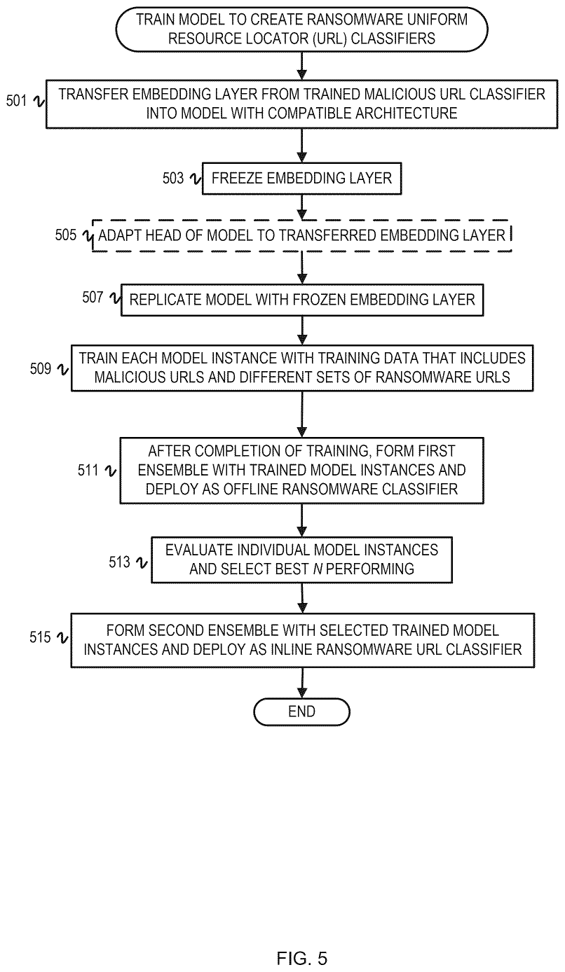

FIGS. 5-7 are flowcharts of example operations for training the classifiers and detecting ransomware URLs with the classifiers. The example operations are described with reference to a training pipeline and a firewall for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. A block presented in dashed line indicates that the represented operation(s) is optional in that flowchart.

FIG. 5 is a flowchart of example operations for training a model to create ransomware URL classifiers. As the training relies on transferring an embedding layer from a trained malicious URL classifier, the architecture of the model to be trained as a ransomware URL classifier is chosen based on compatibility with the embedding layer.

At block 501, a training pipeline transfers an embedding layer from a trained malicious URL classifier into the model to be trained. An example of the model is a convolutional neural network (CNN) or set of CNNs. Other examples of machine learning models that can be trained to be a classifier include a support vector machine, a random forest, a logistic regression model, and a recurrent neural network. Transferring the embedding layer will vary by model and library or application programming interface (API). As an example, the training pipeline can invoke a first function to extract the embedding layer from the trained malicious URL classifier and invoke a second function to add the extracted embedding layer to the model to be trained.

At block 503, the training pipeline freezes the embedding layer. For instance, the training pipeline sets a parameter indicating that the embedding layer is not trainable.

At block 505 (depicted in a dashed line), the training pipeline adapts a head of the model to the transferred embedding layer. The training pipeline adds a CNN or set of CNNs, for example, to the embedding layer with the input layer of the CNNs adapted to receive the outputs of the embedding layer.

At block 507, the training pipeline replicates the model with the frozen embedding layer. A parameter will have been specified/configured indicating a number of instances of the model to replicate. If the untrainable or frozen parameter does not persist in replication, then the training pipeline will freeze the embedding layers across the replicated models.

At block 509, the training pipeline trains each model instance with training data that includes malicious URLs and different sets of ransomware URLs. The training pipeline uses different ransomware URLs for the different model instances to obtain variety in the model instances (i.e., a bagging technique). Thus, an ensemble of these model instances would benefit from the varying performance of the constituent model instances.

At block 511, the training pipeline forms a first ensemble with the trained model instances after training completes. The training pipeline then deploys the first ensemble as an offline ransomware URL classifier. To form the first ensemble, the training pipeline adds an aggregation layer to aggregate the outputs of the constituent models, such as adding a pooling layer. In some embodiments, aggregating can be adding a meta learner if stacked learning was used to train the model instances or base models. If the model instance or base models were trained with a boosting technique, then aggregating can be done with XGBoost (eXtreme Gradient Boosting).

At block 513, the training pipeline evaluates the individual model instances and selects the best n performing of the model instances. As mentioned in the earlier Figures, the training pipeline evaluates the individual model instances with recent ransomware URLs and determines n with the best combination of FPR and TPR.

At block 515, the training pipeline forms a second ensemble with the selected trained model instances. The training pipeline adds an aggregation layer to the selected model instances and deploys as an inline ransomware URL classifier. Deployment, in some embodiments, can include just-in-time compilation of the inline ransomware URL classifier and/or package into a container.

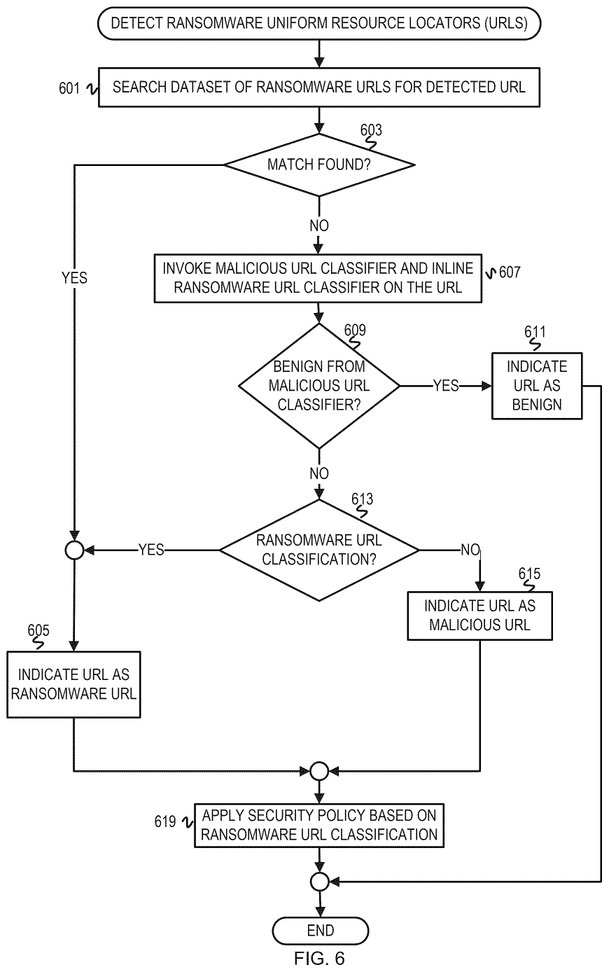

FIG. 6 is a flowchart of example operations for detecting ransomware URLs. The example operations of FIG. 6 correspond to concurrent invocation of a malicious URL classifier and an inline ransomware URL classifier.

At block 601, a firewall searches a dataset of ransomware URLs for a detected URL. The firewall queries a repository that hosts the dataset to determine whether the detected URL is already indicated in the dataset. The dataset includes ransomware URLs identified by domain experts and ransomware URLs detected by the offline ransomware URL classifier. This dataset can be maintained in a local cache facilitating a low latency determination of whether the detected URL is a malicious URL or a ransomware URL based on searching the local cache.

At block 603, the firewall determines whether a match was found in the dataset. If a match was found, then operational flow proceeds to block 605. Otherwise, operational flow proceeds to block 607. Embodiments are not limited to making this decision to continue with the pipeline based on a database of ransomware URLs alone. Embodiments can maintain other categories of malicious URLs and suspicious URLs in a database. If a detected URL matches an entry of any of the different categories of malicious URLs, then the traffic can be quickly blocked without invoking the classifiers. In addition, embodiments can also track benign URLs that are suspicious or have a toxicity rating or suspicious characteristic (e.g., recently registered, old but not used until recently, etc.), and continue with the classifiers if a URL matches an entry that is indicated as benign but suspicious/toxic.

At block 605, the firewall indicates the URL as a ransomware URL. The firewall can create an object that includes the URL and indication of the ransomware URL classification, create a notification, etc. Operational flow proceeds from block 605 to block 619.

If no match was found, then the firewall invokes a malicious URL classifier and separately invokes an inline ransomware URL classifier on the URL at block 607. If either of the classifiers is implemented as a web-based service, the firewall can generate a message or API request that includes the URL and a request for classification. For a local implementation, the firewall can input the URL to the local classifier.

At block 609, the firewall determines whether the URL was classified as benign by the malicious URL classifier. If classified as benign, then operational flow proceeds to block 611. Otherwise, operational flow proceeds to block 613.

At block 611, the firewall indicates the URL as benign. This can be an explicit indication similar to indication of a URL as ransomware discussed with reference to block 605. Indication of the URL can be implicit by not applying a security policy based on the classification or allowing corresponding network traffic to pass. Operational flow ends after block 611 for the detected URL.

If the URL was classified as malicious, then at block 613 the firewall determines whether the inline ransomware URL classifier classified the URL as a ransomware URL. If classified as a ransomware URL, then operational flow proceeds to block 605. If not classified as a ransomware URL, then operational flow proceeds to block 615.

At block 615, the firewall indicates the detected URL as a malicious URL in accordance with the classifications by both classifiers. This verdict of malicious is based on a malicious classification and non-ransomware classification. Operational flow proceeds from block 615 to block 619.

If the detected URL was classified as malicious or as ransomware, then at block 619 the firewall applies a security policy based on the URL classification. A different policy can be configured for a URL classified as a grayware URL or phishing URL than a malware delivery URL or ransomware URL. For instance, the policy may not block network traffic corresponding to a grayware URL but present a warning or delay the network traffic to allow for further analysis. Policies will likely block network traffic corresponding to a malicious URL or ransomware URL, but the policies can assign a higher priority to alerts of ransomware URLs than malicious or grayware URLs.

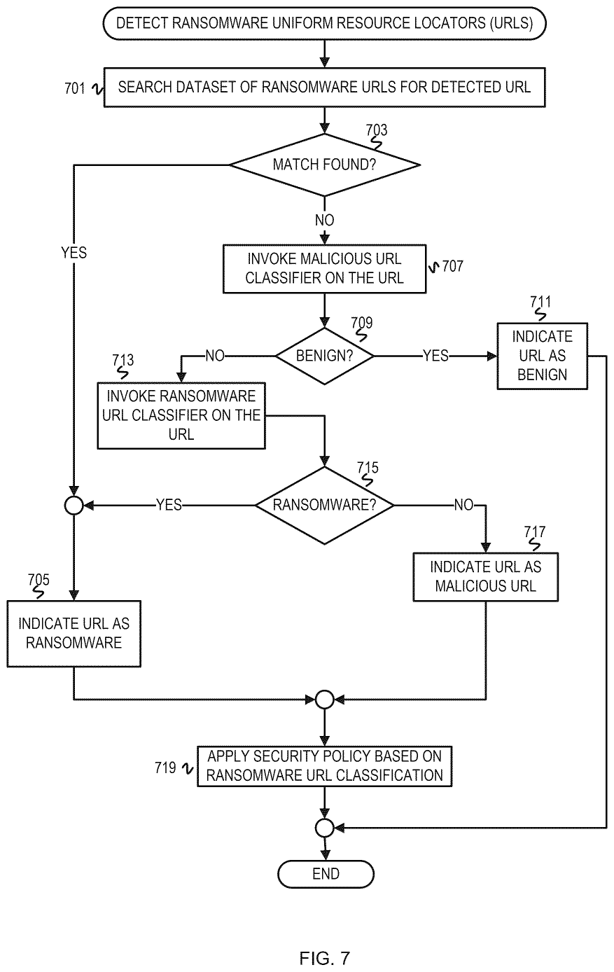

FIG. 7 is a flowchart of example operations for detecting ransomware URLs. The example operations of FIG. 7 correspond to serial invocation of a malicious URL classifier and an inline ransomware URL classifier. Many of the example operations of FIG. 7 are similar to those in FIG. 6. Similar operations are described with brevity instead of repeating language.

At block 701, a firewall searches a dataset of ransomware URLs for a detected URL. At block 703, the firewall determines whether a match was found in the dataset. If a match was found, then operational flow proceeds to block 705. Otherwise, operational flow proceeds to block 707. At block 705, the firewall indicates the URL as a ransomware URL. Operational flow proceeds from block 705 to block 719. If no match was found, then the firewall invokes a malicious URL classifier on the URL at block 707. At block 709, the firewall determines whether the URL was classified as benign by the malicious URL classifier. If classified as benign, then operational flow proceeds to block 711. Otherwise, operational flow proceeds to block 713. At block 711, the firewall indicates the URL as benign. Operational flow ends after block 711 for the detected URL. If the URL was classified as malicious, then at block 713 the firewall invokes an inline ransomware URL classifier. At block 715, the firewall determines whether the inline ransomware URL classifier classified the malicious URL as a ransomware URL. If the URL is classified as a ransomware URL, then operational flow proceeds to block 705. Otherwise, operational flow proceeds to block 717. At block 717, the firewall indicates the detected URL as a malicious URL in accordance with the classifications as malicious and non-ransomware. Operational flow proceeds from block 717 to block 719. At block 719, the firewall applies a security policy based on the URL classification.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 511 can be performed after the operations represented in blocks 513 and 515. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

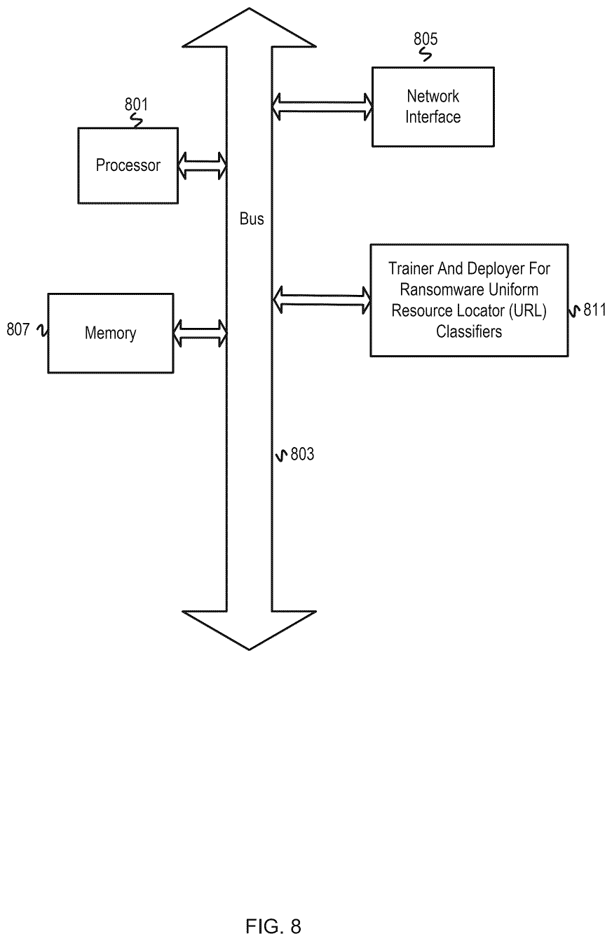

FIG. 8 depicts an example computer system with a trainer and deployer for ransomware URL classifiers. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a trainer and deployer 811 for ransomware URL classifiers. The trainer and deployer 811 can be implemented as a pipeline that trains an ensemble of models to be a ransomware URL classifier based on transfer learning from a trained malicious URL classifier having a similar architecture as the ensemble of models. The use of transfer learning from the trained malicious URL classifier was shown to improve TPR of the ransomware URL classifier by approximately 25% at a FPR of 0.5%. After transferring an embedding layer from the trained malicious URL classifier, the trainer and deployer 811 replicates the ensemble of models to generate n instances of the ensemble of models and sets the transferred embedding layer to be frozen/untrainable. The trainer and deployer 811 then trains the ensembles with training data that includes malicious URLs that are ransomware URLs and malicious URLs that are non-ransomware URLs. To create ensembles with different performance capabilities with different fittings, the trainer and deployer 811 trains each of the ensembles with a different set of ransomware URLs. After training, the trainer and deployer 811 aggregates the ensembles and deploys the aggregated ensembles as an offline classifier. The trainer and deployer 811 selects a subset of the ensembles based on performance criteria and forms an inline classifier with the selected subset. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
classifying a first uniform resource locator (URL) as a ransomware URL or a benign, wherein classifying the first URL comprises,
determining a malicious classification for the first URL with a first classifier;
determining a ransomware classification for the first URL with a second classifier, wherein the second classifier comprises a first ensemble of classifiers that have been trained based, at least partly, on transfer learning from a trained malicious URL classifier and training data comprising ransomware URLs;
classifying the first URL as a ransomware URL if the first classifier classifies the first URL as a malicious URL and the second classifier classifies the first URL as a ransomware URL;
classifying the first URL as benign if the first classifier classifies the URL as benign; and
if the first URL is classified as a ransomware URL, then blocking access to the first URL or indicating that access to the first URL should be blocked.

2. The method of claim 1 further comprising inline detecting the first URL in network traffic on a firewall.

3. The method of claim 1, wherein the second classifier is hosted locally or accessible via a web-based service.

4. The method of claim 1 further comprising:
retraining a third classifier with recent training data comprising malicious URLs that are not ransomware URLs and malicious URLs that are ransomware URLs,
wherein the third classifier comprises a second ensemble of classifiers that have been trained based, at least partly, on transfer learning from the trained malicious URL classifier and the training data comprising ransomware URLs,
wherein the second classifier is a subset of the third classifier before retraining of the third classifier; and
selecting a subset of the retrained third classifier as a fourth classifier and replacing the second classifier with the fourth classifier.

5. The method of claim 4, wherein selecting the subset of the retrained third classifier comprises evaluating performance of different subsets of the classifiers of the second ensemble and selecting the best performing subset of classifiers.

6. The method of claim 1, wherein the second classifier is packaged for just-in-time inference.

7. The method of claim 1 further comprising obtaining a local cache of a dataset of malicious URLs including ransomware URLs and searching the local cache, prior to determining the malicious classification with the first classifier, for the first URL classify the first URL as a malicious URL or ransomware URL if a corresponding match is found in the local cache, wherein at least some of the ransomware URLs in the dataset were classified by a third classifier of which the first classifier is a subset.

8. A non-transitory, machine-readable medium having program code stored thereon, the program code comprising instructions to:
transfer a first embedding layer from a first classifier trained for malicious uniform resource locator (URL) classification into a first ensemble of machine learning models;
freeze the first embedding layer in the first ensemble;
replicate the first ensemble to generate a plurality of ensembles with the frozen embedding layer;
train the plurality of ensembles to classify a malicious URL as malicious ransomware URL or a malicious non-ransomware URL, wherein training is with at least a first subset of a dataset that comprises malicious ransomware URLs and non-ransomware malicious URLs and wherein each of the plurality of ensembles is trained with a different subset of the malicious ransomware URLs; and
deploy a first subset of the trained plurality of ensembles as an inline ransomware URL classifier.

9. The machine-readable medium of claim 8, wherein the program code to deploy the first subset of the trained plurality of ensembles comprise instructions to evaluate different combinations of the trained plurality of ensembles and select a best performing combination, wherein the first subset is the best performing combination.

10. The machine-readable medium of claim 8, wherein the program code further comprises instructions to deploy the plurality of trained ensembles as an offline ransomware URL classifier that continuously receives malicious URLs from one or more data sources of malicious URLs.

11. The machine-readable medium of claim 8, wherein the program code further comprises instructions to split the dataset at least into a training set and a testing set, wherein the testing set comprises samples of the dataset within a most recent predefined time period and the training set is the first subset.

12. The machine-readable medium of claim 8, wherein the first ensemble comprises a plurality of artificial neural network (ANN) based models, each of the models coupled to the first embedding layer to receive a different channel of embeddings from the first embedding layer, wherein the channels of embeddings at least comprise character based embeddings and token based embeddings.

13. The machine-readable medium of claim 12, wherein the ANN is a convolutional neural network.

14. The machine-readable medium of claim 8, wherein the program code further comprises instructions to aggregate the trained plurality of ensembles to generate a trained ransomware URL classifier.

15. The machine-readable medium of claim 14, wherein the instructions to aggregate the trained plurality of ensembles comprise instructions to aggregate according to the XGBoost algorithm.

16. A system comprising:
a first classifier that has been trained to classify a malicious uniform resource locator (URL) as a ransomware URL or a non-ransomware URL; and
a first apparatus comprising a first processor and a first machine-readable medium having instructions stored thereon that are executable by the first processor to cause the first apparatus to,
invoke a second classifier to classify a detected URL as malicious or benign, wherein the second classifier has been trained to classify a URL as malicious or benign;
invoke the first classifier to classify the detected URL as a ransomware URL or non-ransomware URL;
generate a benign verdict if the second classifier classifies the detected URL as benign; and
generate a ransomware verdict if the second classifier classifies the detected URL as malicious and the first classifier classifies the detected URL as a ransomware URL.

17. The system of claim 16 further comprising:
a third classifier that has been trained to classify a malicious uniform resource locator (URL) as a ransomware URL or a non-ransomware URL; and
a second apparatus comprising a second processor and a second machine-readable medium having instructions stored thereon that are executable by the second processor to cause the second apparatus to collect over time data indicating malicious URLs and ransomware URLs from a plurality of sources, to invoke the third classifier to classify the collected malicious URLs, and to update a dataset with indications of the collected ransomware URLs and those of the collected malicious URLs classified by the third classifier as ransomware URLs,
wherein the first machine-readable medium further has instructions stored thereon that are executable by the first processor to cause the first apparatus to search the dataset for the detected URL,
wherein the instructions to generate the ransomware verdict are also executable by the first processor to cause the first apparatus to also generate the ransomware verdict if the detected URL is found in the dataset.

18. The system of claim 16, wherein the first apparatus further comprises a local cache of the dataset and the first machine-readable medium further has stored thereon instructions executable by the first processor to cause the first apparatus to search the local cache, prior to invocation of the second classifier, for a detected URL and generate a verdict if a match in the local cache is found.

19. The system of claim 16, wherein the first apparatus comprises a firewall.

20. The system of claim 16, wherein the instructions to invoke the first classifier comprise the instructions executable by the first processor to cause the first apparatus to generate an application programming interface call to a web-based service that classifies a URL with the first classifier.
